(19) United States
(12) Patent Application Publication
(10) Pub. No.: US 2008/0130538 A1
(43) Pub. Date: Jun. 5, 2008

(54) ENHANCED MANAGEMENT FRAME AGGREGATION IN A WIRELESS NETWORK SYSTEM

(75) Inventors: Alireza Raissinia, Monte Sereno, CA (US); Guido Robert Frederiks, Campbell, CA (US); Vincent K. Jones, Redwood City, CA (US)

Correspondence Address: Amin, Turocy & Calvin LLP, 1900 E. 9th Street, 24th Floor, National City Center, Cleveland, OH, 44114, US

(73) Assignee: QUALCOMM INCORPORATED, San Diego, CA (US)

(21) Appl. No.: 11/947,735

(22) Filed: Nov. 29, 2007

Related U.S. Application Data
(60) Provisional application No. 60/868,706, filed on Dec. 5, 2006.
(60) Provisional application No. 60/869,072, filed on Dec. 7, 2006.

(51) Int. Cl. H04B 7/00

(52) U.S. Cl. 370/310

(57) ABSTRACT

Systems and methodologies are described that facilitate enhanced aggregation of management frames in a wireless communication system. Various aspects described herein provide for the encapsulation of management frames into respective data frames, thereby allowing management frames to be aggregated with data frames. Upon aggregation of an encapsulated management frame with data frames, the aggregated frames can be transmitted to one or more stations using a block acknowledgement scheme. Further, information contained in a management frame can be encrypted prior to transmission. Upon transmission of an aggregated frame, indications can be provided to a receiving station to indicate the presence of an encapsulated management frame and/or encrypted management information within the aggregated frame. Based on these indications, the receiving station can extract and/or decrypt the management information from the aggregated frame.

### CROSS-REFERENCE

This application claims the benefit of U.S. Provisional Application Ser. No. 60/868,706, filed Dec. 5, 2006, entitled “ENHANCED MANAGEMENT FRAME AGGREGATION IN A WIRELESS NETWORK SYSTEM,” and U.S. Provisional Application Ser. No. 60/869,072, filed Dec. 7, 2006, entitled “ENHANCED MANAGEMENT FRAME AGGREGATION IN A WIRELESS NETWORK SYSTEM,” both of which are fully incorporated herein by reference in their entirety.

### FIELD

The subject disclosure relates generally to wireless communications, and more specifically to techniques for frame aggregation in a wireless communication system.

### BACKGROUND

Wireless communication systems are widely deployed to provide various communication services; for instance, voice, video, packet data, broadcast, and messaging services may be provided via such wireless communication systems. These systems may be multiple-access systems that are capable of supporting communication for multiple terminals by sharing available system resources. Examples of such multiple-access systems include Code Division Multiple Access (CDMA) systems, Time Division Multiple Access (TDMA) systems, Frequency Division Multiple Access (FDMA) systems, and Orthogonal Frequency Division Multiple Access (OFDMA) systems.

As wireless networks have grown in popularity, the demand for bandwidth on such networks has increased. Accordingly, wireless network design techniques are continually evolving to meet this demand. Typically, the bandwidth required for and/or used by a wireless communication system depends on the amount of data to be transferred within the system and any overhead associated with transferring that data. Overhead can come from various sources, such as addressing and error-checking information, control information, and re-transmission of corrupted information. As overhead increases, throughput of data decreases, making the network less efficient.

One conventional approach to increasing data throughput is to increase the bit rate of data streams being transmitted. Increasing the bit rate, however, can result in little or no increase in throughput due to the fact that increasing bit rate also increases bit error rate. As a result, an increasing fraction of available bandwidth might be used as the bit rate of data streams increases to retransmit corrupted information. Another conventional approach to increasing data throughput is to improve transmission efficiency such that more available bandwidth can be used for data transmissions rather than overhead associated with the data transmissions. This can be accomplished by, for example, aggregating data frames to be transmitted. However, while data frames can ordinarily be aggregated in an efficient manner, efficient frame aggregation techniques do not exist for management frames, which can also contribute significant overhead. Therefore, there exists a need for aggregation techniques that can provide a reduction in management frame overhead.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

According to an aspect, a method for transmitting information in a wireless communication system is described herein. The method can comprise identifying a plurality of frames to be transmitted, the frames comprising one or more data frames for communicating data within the wireless communication system according to a data frame protocol and one or more management frames for communicating management information within the wireless communication system according to a management frame protocol; and encapsulating a management frame into a data frame such that the management frame can be communicated as a data frame according to the data frame protocol.

Another aspect relates to a wireless communications apparatus that can comprise a memory that stores data relating to one or more management frames. The wireless communications apparatus can further include a processor configured to encapsulate the one or more management frames into respective data frames and to aggregate the encapsulated management frames into one or more aggregated frames.

Yet another aspect relates to an apparatus that facilitates frame aggregation in a wireless communication system. The apparatus can comprise means for receiving one or more data frames and one or more management frames; means for encapsulating the management frames into one or more data frames; and means for aggregating the one or more received data frames and the encapsulated management frames.

Still another aspect relates to a computer-readable medium, which can comprise code for causing a computer to identify a plurality of frames for transmission, the frames comprising at least one data frame and at least one management frame; code for causing a computer to encapsulate a management frame into a data frame such that the management frame can be communicated as a data frame; code for causing a computer to aggregate the encapsulated management frame with one or more data frames or previously encapsulated management frames; and code for causing a computer to instruct transmission of the aggregated frames with a request for a block acknowledgment in response to the aggregated frames.

According to another aspect, an integrated circuit is described herein that can execute computer-executable instructions for coordinating transmission of management information. The instructions can comprise receiving a management frame to be transmitted; and encapsulating the management frame into a data frame to enable aggregation and transmission of the management frame as a data frame.

According to an additional aspect, a method for processing information in a wireless communication system is described herein. The method can comprise receiving an aggregate frame, the aggregate frame comprises a plurality of subframes constructed according to a data frame format, at least one subframe contains a management frame containing management information; de-aggregating the aggregate frame to obtain the subframes contained within the aggregate frame; and obtaining management information from a subframe at least in part by decapsulating the subframe to obtain a management frame contained therein.

Another aspect relates to a wireless communications apparatus that can comprise a memory that stores data relating to an aggregated frame comprising a plurality of data frames. The wireless communications apparatus can further comprise a processor configured to obtain the plurality of data frames from the aggregated frame and to derive management information from a data frame at least in part by extracting a management frame from the data frame.

Yet another aspect relates to an apparatus that facilitates receiving and processing an aggregated frame in a wireless communication system. The apparatus can comprise means for receiving an aggregated data frame containing a plurality of data frames; means for de-aggregating the aggregated data frame into the plurality of data frames; and means for decapsulating respective management frames from respective data frames in which management frames are encapsulated.

Still another aspect relates to a computer-readable medium, which can comprise code for causing a computer to identify an aggregate frame comprising a plurality of data subframes; code for causing a computer to identify a data subframe that contains a management frame; and code for causing a computer to extract the management frame from the identified data subframe.

A further aspect relates to an integrated circuit that can execute computer-executable instructions for obtaining management information from an aggregate frame. The instructions can comprise receiving an aggregate frame comprising a plurality of subframes; identifying information provided in one or more subframes that indicates the presence of respective management frames encapsulated in the one or more subframes; and decapsulating the one or more subframes in which respective management frames are encapsulated to extract the management frames.

To the accomplishment of the foregoing and related ends, one or more aspects of the claimed subject matter comprise the features hereinafter fully described and particularly pointed out in the claims. The following description and the annexed drawings set forth in detail certain illustrative aspects of the claimed subject matter. These aspects are indicative, however, of but a few of the various ways in which the principles of the claimed subject matter may be employed. Further, the disclosed aspects are intended to include all such aspects and their equivalents.

### BRIEF DESCRIPTION OF THE DRAWINGS

FIG. 1 illustrates a wireless multiple-access communication system in accordance with various aspects set forth herein.

FIG. 2 is a block diagram of a system for frame aggregation in a wireless communication system in accordance with various aspects.

FIG. 3 illustrates an example management frame structure in accordance with various aspects.

FIGS. 4A-4B illustrate example management frame transmissions in a wireless communication system.

FIGS. 5-7 illustrate example frame aggregation schemes that can be employed in a wireless communication system in accordance with various aspects.

FIG. 8 is a block diagram of a system for management frame encapsulation and aggregation in accordance with various aspects.

FIG. 9 illustrates example data frame structures in accordance with various aspects.

FIG. 10 illustrates an example encapsulation technique for a management frame in accordance with various aspects.

FIG. 11 is a flow diagram of a methodology for enhanced management frame aggregation in a wireless communication system.

FIG. 12 is a flow diagram of a methodology for management frame encapsulation and aggregation.

FIG. 13 is a flow diagram of a methodology for receiving and processing aggregated management frames.

FIG. 14 is a block diagram illustrating an example wireless communication system in which one or more aspects described herein may function.

FIG. 15 is a block diagram of an apparatus that facilitates enhanced management frame aggregation in a wireless communication system.

FIG. 16 is a block diagram of an apparatus that facilitates utilization of aggregated and encapsulated management frames in a wireless communication system.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may become evident, however, that such aspect(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment. A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various aspects or features described herein can be implemented as a method, apparatus, or article of manufacture using programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

Various aspects will be presented in terms of systems that can include a number of devices, components, modules, and the like. It is to be understood and appreciated that the various systems can include additional devices, components, modules, etc. and/or can not include all of the devices, components, modules etc. discussed in connection with the figures. A combination of these approaches can also be used.

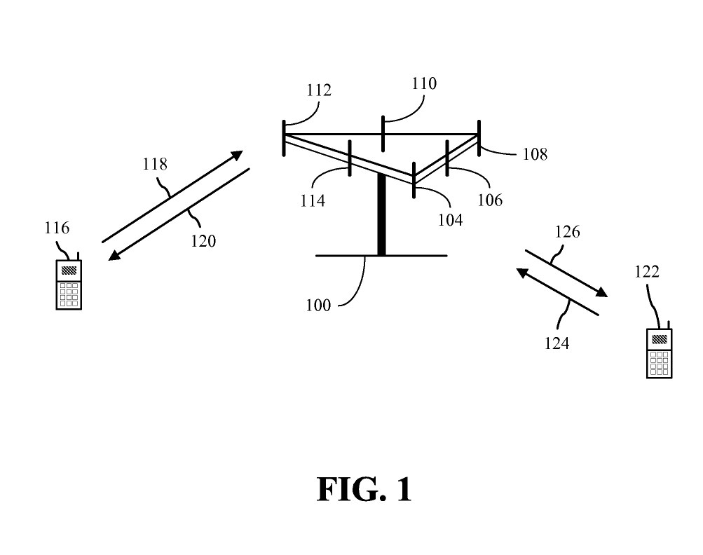

Referring now to the drawings, FIG. 1 is an illustration of a wireless multiple-access communication system in accordance with various aspects. In one example, an access point 100 (AP) includes multiple antenna groups. As illustrated in FIG. 1, one antenna group can include antennas 104 and 106, another can include antennas 108 and 110, and another can include antennas 112 and 114. While only two antennas are shown in FIG. 1 for each antenna group, it should be appreciated that more or fewer antennas may be utilized for each antenna group. In another example, an access terminal 116 (AT) can be in communication with antennas 112 and 114, where antennas 112 and 114 transmit information to access terminal 116 over forward link 120 and receive information from access terminal 116 over reverse link 118. Additionally and/or alternatively, access terminal 122 can be in communication with antennas 106 and 108, where antennas 106 and 108 transmit information to access terminal 122 over forward link 126 and receive information from access terminal 122 over reverse link 124. In a frequency division duplex (FDD) system, communication links 118, 120, 124 and 126 can use different frequency for communication. For example, forward link 120 may use a different frequency then that used by reverse link 118.

Each group of antennas and/or the area in which they are designed to communicate can be referred to as a sector of the access point. In accordance with one aspect, antenna groups can be designed to communicate to access terminals in a sector of areas covered by access point 100. In communication over forward links 120 and 126, the transmitting antennas of access point 100 can utilize beamforming in order to improve the signal-to-noise ratio of forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point, e.g., access point 100, can be a fixed station used for communicating with terminals and can also be referred to as a base station, a Node B, an access network, and/or other suitable terminology. In addition, an access terminal, e.g., an access terminal 116 or 122, can be a fixed or mobile station for communicating with access points and can be referred to as a mobile terminal, user equipment (UE), a wireless communication device, a terminal, a wireless terminal, and/or other appropriate terminology.

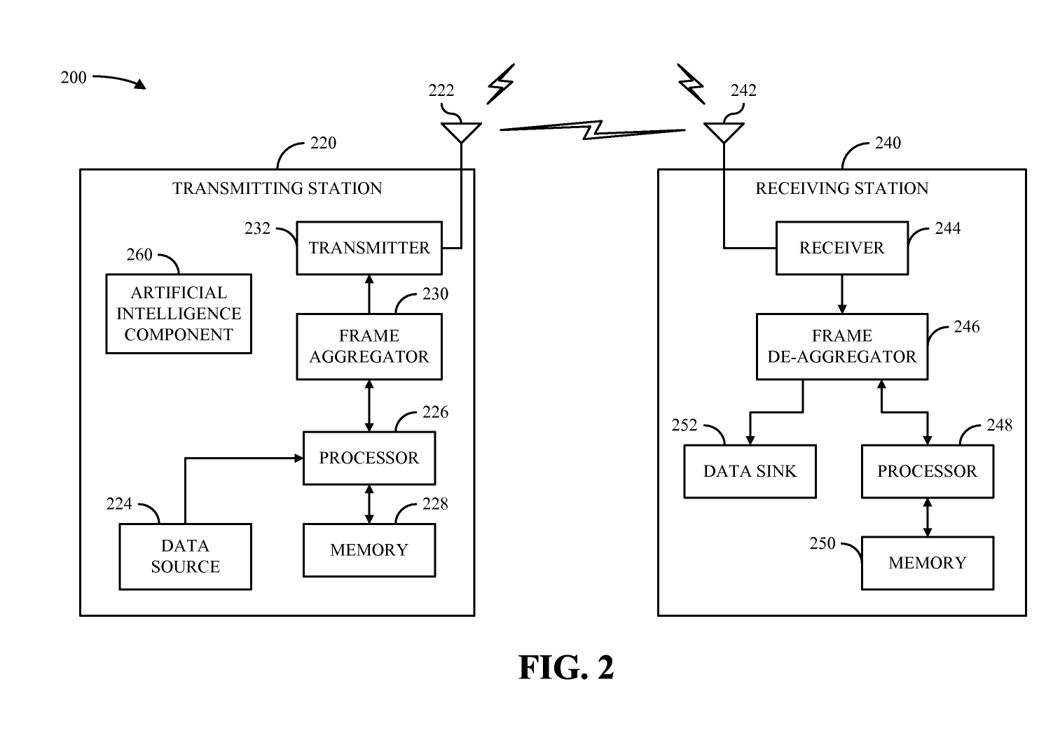

FIG. 2 is a block diagram of a system 200 for frame aggregation in a wireless communication system in accordance with various aspects described herein. System 200 can include one or more stations, such as a transmitting station 220 and a receiving station 240, which can communicate via respective antennas 222 and 242. Transmitting station 220 and/or receiving station 240 can be, for example, base stations (e.g., access points 100), user terminals (e.g., access terminals 116 and/or 122), and/or any other suitable network entity. For example, transmitting station 220 can be a base station, receiving station 240 can be a terminal, and stations 220 and 240 can communicate using Basic Service Set (BSS) networking. Alternatively, transmitting station 220 and receiving station 240 can both be terminals, which can communicate using Independent BSS (IBSS) networking without requiring an access point. Although only one antenna is illustrated at stations 220 and 240, it should be appreciated that stations 220 and 240 can communicate using any number of antennas. Further, while FIG. 2 designates station 220 as a transmitting station and station 240 as a receiving station, it should be appreciated that similar techniques to those illustrated in FIG. 2 could also be applied for communication from receiving station 240 to transmitting station 220.

In accordance with one aspect, transmitting station 220 can communicate information such as data and/or control signaling to receiving station 240 on the forward link. This information can include, for example, data obtained from a data source 224 and/or another appropriate source, control signaling generated and/or otherwise obtained by a processor 226, and/or any other appropriate information for transmission to receiving station 240. In one example, processor 226 or another suitable entity can identify data, control signaling, and other information to be transmitted by transmitting station 220 and place the information into respective frames. To facilitate this process, processor 226 can interact with memory 228.

In accordance with another aspect, frames transmitted by transmitting station 220 can include data frames and/or management frames. In one example, data frames can be constructed, for example, using data obtained from data source 224 and/or another suitable source of data. In accordance with one aspect, data frames can be communicated and processed by transmitting station 220 and receiving station 240 according to one or more data frame protocols. Further, to reduce overhead associated with data frames and to increase the overall data throughput of system 200, transmitting station 220 can aggregate multiple data frames using a frame aggregator 230 prior to transmission via transmitter 232 and antenna 222. This can be accomplished, for example, by grouping multiple data frames into an aggregate frame for block transmission to one or more receiving stations 240 and/or other entities. To facilitate transmission of multiple frames within an aggregate frame without requiring a separate response for each frame, the frames can be provided with a quality of service (QoS) control field and/or another similar field in order to allow a station receiving the aggregate frame to wait for the conclusion of an aggregate frame and provide a single response for the aggregate frame. Techniques by which data frames can be aggregated and utilized are described in more detail infra.

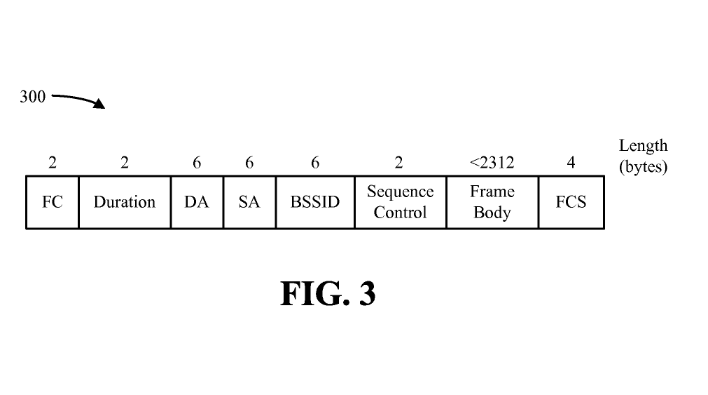

In another example, management frames can be constructed by processor 226 and/or another appropriate entity to convey information that facilitates the establishment and maintenance of a communication link between transmitting station 220 and receiving station 240. In accordance with one aspect, management frames can be communicated and processed by transmitting station 220 and receiving station 240 using one or more management frame protocols, which can be the same as or different than the data frame protocols used for data frames. An example format that can be used for the construction of a management frame is illustrated by diagram 300 in FIG. 3. As illustrated by diagram 300, a management frame can begin with a 2-byte Frame Control (FC) field. In one example, the FC field can contain a type field that identifies the frame as a management frame as well as a subtype field that identifies the type and/or function of the management frame. By way of non-limiting example, the FC field of a management frame can identify the frame as a beacon frame, an association request and/or response frame, a re-association request and/or response frame, a disassociation request frame, an authentication and/or de-authentication frame, a probe request and/or response frame, an action frame, and/or another appropriate management frame subtype. As illustrated in diagram 300, a management frame can further comprise a 2-byte duration field, a 6-byte Destination Address (DA) field, a 6-byte Source Address (SA) field, a 6-byte Basic Service Set Identifier (BSSID) field, a 2-byte Sequence Control field, a frame body of up to 2312 bytes, and a 4-byte Frame Check Sequence (FCS).

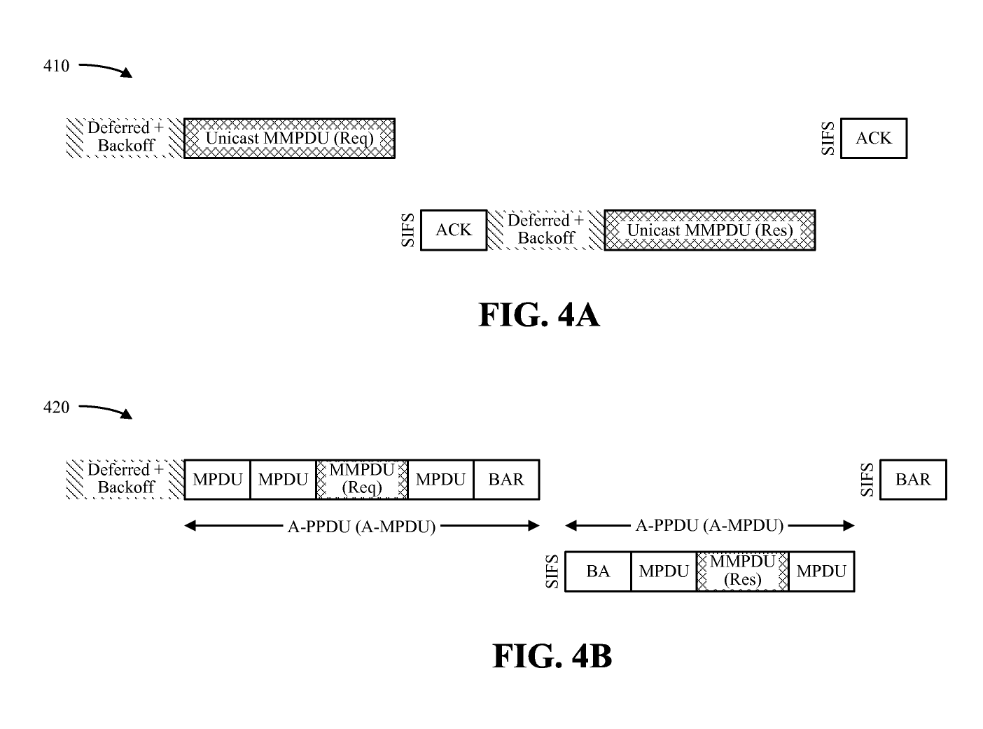

Once one or more management frames generated by transmitting station 220 have been constructed using the structure illustrated in diagram 300 and/or another appropriate structure, they can be transmitted to one or more receiving stations 240 via transmitter 232 and antenna 222. However, unlike data frames, there have traditionally been no mechanisms by which management frames can be aggregated prior to transmission. As a result, there has been a loss in efficiency and throughput of wireless communication systems employing data and management frames. As an example, diagram 410 in FIG. 4A illustrates a transmission timeline for a unicast management frame. As diagram 410 generally illustrates, transmission of a unicast management frame follows a sequence in which the initiator of a management frame exchange first transmits a MMPDU (Medium Access Control (MAC) Management Protocol Data Unit) within a management frame. Following transmission of the MMPDU, the transmitter waits for a Short Interframe Spacing (SIFS) period for an acknowledgement (ACK) and/or a similar response before proceeding with a following management frame. Traditionally, management frames do not contain a QoS Control Field and/or other such information to allow their aggregation, and as a result each management frame requires its own response before other frames can be transmitted. Thus, a SIFS waiting period follows each transmitted management frame, which reduces the overall efficiency of the system and undermines the performance gains provided by data frame aggregation. Further, because the number of management frames for correct operation of the system can increase as the bit rate of the system increases, the efficiency loss experienced by a system due to management frame response time can increase as the bit rate of the system increases.

In accordance with one aspect, system 200 can mitigate the above shortcomings associated with management frame response times by aggregating management frames with data frames at frame aggregator 230. In one example, to allow the aggregation of management frames, the management frames can be encapsulated into respective data frames by frame aggregator 230. The data-encapsulated management frames can then be aggregated with other data frames and transmitted to receiving stations 240 and/or other entities in system 200 using one or more communication protocols designated within system 200 for data frames. As a result, both management and data frames can be communicated and processed in block transmissions without requiring a separate waiting period for each management frame. This is further illustrated by diagram 420 in FIG. 4B. As illustrated in diagram 420, a management frame, e.g., an MMPDU, can be encapsulated in a data frame and aggregated with other data frames, e.g., data MPDUs (MAC Protocol Data Units), such that one acknowledgement period is needed in connection with the transmission of each aggregated frame.

In one example, a Block Acknowledgement Request (BAR) can be provided at the end of an aggregated frame, which can correspond to each data and/or management subframe in the transmitted aggregated frame. In response, a receiver can provide a Block Acknowledgement (BA) that can specify acknowledgments and/or negative acknowledgements for each subframe in the transmitted aggregated frame. In one example, subframes for which negative acknowledgements are specified in a block acknowledgment can be re-transmitted to the receiver. Such subframes can be aggregated into a new aggregate frame and/or transmitted individually to the receiver.

While diagram 420 illustrates an explicit BAR communicated using a designated subframe within an aggregated frame, it should be appreciated that a BAR can also be made implicit by, for example, embedding acknowledgment policy information and/or other suitable information to convey a block acknowledgment request to the receiver in the final subframe of an aggregated frame. As diagram 420 further illustrates, data and management frames can be aggregated in an Aggregate PLCP (Physical Layer Convergence Procedure) Protocol Data Unit (A-PPDU), an Aggregate MPDU (A-MPDU), and/or any other suitable aggregate frame structure. Frame aggregation techniques utilizing these and other aggregate frame structures are described in more detail infra.

Referring back to FIG. 2, aggregated frames transmitted by transmitting station 220 can be received by receiving station 240 via antenna 242 and receiver 244. Received aggregated frames can then be provided to a frame de-aggregator 246 to obtain data and/or management information contained in the aggregated frames. In one example, frame de-aggregator 246 can operate in cooperation with a processor 248, which can in turn interact with memory 250. In another example, data and/or management information obtained from aggregated frames processed by frame de-aggregator 246 can be provided to a data sink 252 and/or processor 248.

In accordance with one aspect, data-encapsulated management frames transmitted in an aggregated frame can include respective indications that the frames contain management information. Based on these indications, frame de-aggregator 246 can decapsulate the data-encapsulated management frames to obtain the management information stored therein. Additionally and/or alternatively, frame aggregator 230 at transmitting station 220 can encrypt one or more management frames prior to or subsequent to encapsulation and aggregation. Frame aggregator 230 can additionally provide indications of encrypted management information within respective encapsulated management frames, and based on these indications frame de-aggregator 246 at receiving station 240 can perform an appropriate decryption algorithm to obtain the management information provided in the encrypted frames.

In accordance with a further aspect, transmitting station 220 and/or receiving station 240 can further include an artificial intelligence (AI) component 260. The term “intelligence” refers to the ability to reason or draw conclusions about, e.g., infer, the current or future state of a system based on existing information about the system. Artificial intelligence can be employed to identify a specific context or action, or generate a probability distribution of specific states of a system without human intervention. Artificial intelligence relies on applying advanced mathematical algorithms—e.g., decision trees, neural networks, regression analysis, cluster analysis, genetic algorithm, and reinforced learning—to a set of available data (information) on the system. In particular, AI component 260 can employ one of numerous methodologies for learning from data and then drawing inferences from the models so constructed, e.g., hidden Markov models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches (that perform data fusion, etc.) in accordance with implementing various automated aspects described hereinafter.

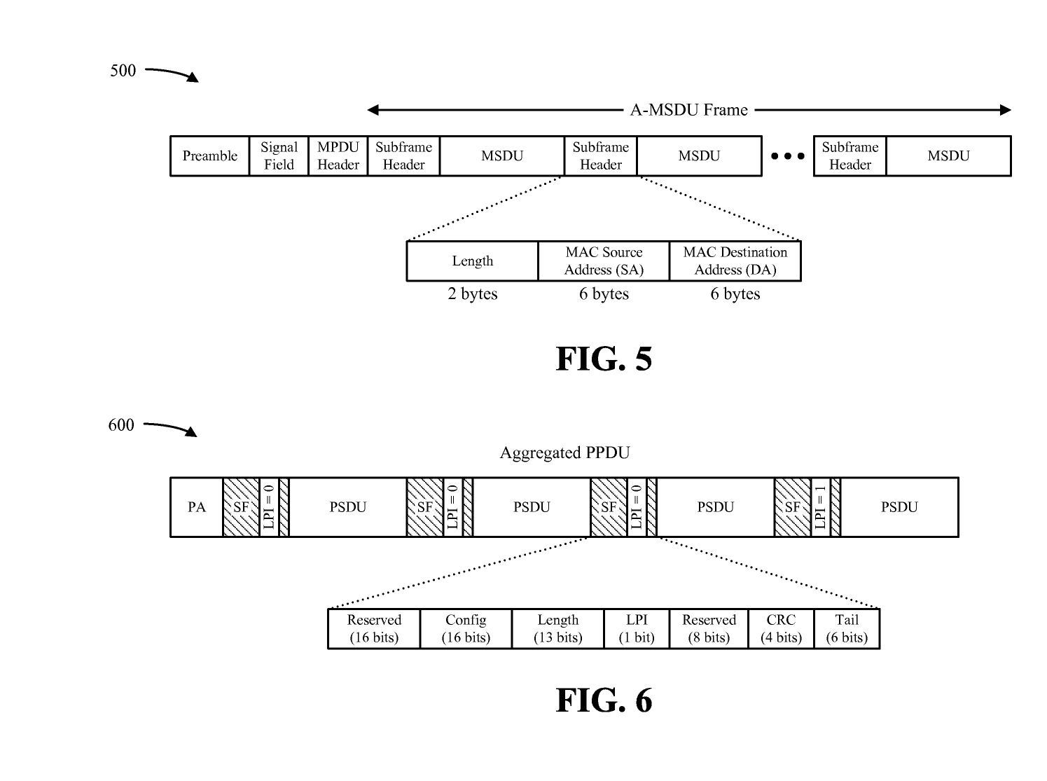

Turning to FIGS. 5-7, various aggregation schemes that can be used for the aggregation of data frames in a wireless communication system (e.g., by frame aggregator 230) are illustrated. It should be appreciated, however, that the aggregation schemes described herein are provided by way of non-limiting example and that other aggregation schemes could be utilized. Referring specifically to FIG. 5, a diagram 500 is provided that illustrates Aggregate MAC Service Data Unit (A-MSDU) frame aggregation. In accordance with one aspect, A-MSDU frame aggregation is an efficient form of aggregation for data frames. For example, MSDU frames destined to a single receiver can be formed into an A-MSDU aggregated frame such that overhead associated with inter-frame space time (IFS) and physical layer (PHY) overhead (e.g., overhead associated with Preamble and Signal Field) is minimized. As illustrated by diagram 500, A-MSDU frame aggregation can utilize a subframe header to delineate each MSDU in an aggregated frame. In one example, each subframe header can be 14 bytes and include a two-byte Length field, a six-byte Source Address (SA) field, and a six-byte Destination Address (DA) field. Based on the structure illustrated by diagram 500, an A-MSDU frame can be handled by the lower layer MAC (e.g., for encryption, queue management, address filtering and/or forwarding, and the like) as if the A-MSDU frame was a single MSDU frame.

A-MSDU frame aggregation as illustrated by diagram 500, however, has traditionally been ineffective for aggregation of management frames. For example, because an A-MSDU frame is encapsulated into a single MPDU, it can contain a single Frame Control (FC) field. Because a Frame Control field can contain Type and Subtype fields to indicate the type of frame being transmitted, the Type and Subtype fields should be the same for all MSDUs within an A-MSDU frame. Thus, management frames cannot be aggregated with data frames and/or other frames within an A-MSDU frame. As a result, except in instances where an initiator of an A-MSDU frame has several pending management frames for a single receiver, management frames cannot be aggregated using A-MSDU. Further, while an A-MSDU frame can include a Quality of Service (QoS) control field, which can be used by a transmitter to inform a receiver as to the presence of the A-MSDU aggregated frame, management frames generally do not contain a QoS Control Field. For example, example formats for the QoS Control Field are illustrated in the following table:

TABLE 1
QoS Control Field formats for an A-MSDU frame.

| Applicable Frame | Bits | | | | |
|---|---|---|---|---|---|
| (Sub) Types | 0-3 | Bit 4 | Bit 5-6 | Bit 7 | Bits 8-15 |
| QoS (+) CF-Poll frames | TID | EOSP | Ack | Reserved | TXOP limit |
| sent by HC | | | Policy | | |
| QoS Data and QoS Data + CF- | TID | EOSP | Ack | A-MSDU | QAP PS Buffer |
| Ack frames sent | | | Policy | Present | State |
| by HC | | | | | |
| QoS Null, QoS CF-Ack | TID | EOSP | Ack | Reserved | QAP PS Buffer |
| frames sent by HC | | | Policy | | State |
| QoS data type frames | TID | 0 | Ack | A-MSDU | TXOP duration |
| sent by non-AP QSTAs | | | Policy | Present | requested |
| | TID | 1 | Ack | A-MSDU | Queue size |
| | | | Policy | Present | |

As listed in Table 1, QoS Control Field formats for various frame types and subtypes within an A-MSDU frame are provided. For example, for a Contention Free (CF)-Poll frame sent by a Hybrid Coordinator (HC), a QoS Control Field can contain a 4-bit Traffic Identifier (TID) followed by a 1-bit End of Service Period (EOSP) indication, a 2-bit Acknowledgement (Ack) policy, a reserved bit, and an 8-bit Transmission Opportunity (TXOP) limit. For a QoS Data frame and/or a combined QoS Data and CF-Ack frame sent by a HC, a QoS Control Field can contain a 4-bit TID followed by a 1-bit EOSP indication, a 2-bit Ack policy, a 1-bit A-MSDU indication, and an 8-bit QoS Access Point Power Save (QAP PS) buffer state. For QoS Null and/or QoS CF-ACK frames sent by a HC, a QoS Control Field can contain a 4-bit TID, a 1-bit EOSP indication, a 2-bit Ack policy, a reserved bit, and an 8-bit QAP PS buffer state. For QoS data frames sent by non-AP QoS Stations (QSTAs), a QoS Control Field can contain a 4-bit TID, a fixed bit, a 2-bit Ack policy, a 1-bit A-MSDU indication, and either an 8-bit TXOP duration request or an 8-bit queue size depending on the value of the fixed bit following the TID.

FIG. 6 comprises a diagram 600 that illustrates A-PPDU frame aggregation. In accordance with one aspect, A-PPDU frame aggregation is a robust form of frame aggregation that utilizes the physical layer to provide a delineation field for MPDUs and/or Physical Layer Service Data Units (PSDUs). In A-PPDU aggregation, each MPDU and/or PSDU in an aggregated frame can contain a single MSDU, a data A-MSDU, or a portion of a data A-MSDU and can be destined to multiple receivers. In operation, the MAC Service Access Point (SAP) can request the use of A-PPDU frame aggregation from the PHY SAP such that appropriate fields, such as the Signal Field (SF), are inserted at the beginning of each PSDU to be aggregated. Additionally, pad bits can be appended to the end of each PSDU such that a transmission of the PSDUs ends at an OFDM symbol boundary.

As diagram 600 illustrates, an aggregated PPDU frame includes a SF for each PSDU in the aggregated frame. In one example, the SF can contain a 16-bit Config field, which can provide information regarding rate, modulation, number of antennas, and the like. The SF can further contain a 13-bit Length field, a 1-bit Last Packet Indicator (LPI) bit, a 4-bit Cyclic Redundancy Check (CRC) field, and a 4-bit Tail field. The SF can additionally contain Reserved fields of 16 bits and 8 bits, respectively. In one example, each SF can be transmitted using Quadrature Phase-Shift Keying (QPSK). As a result, robust frame aggregation can be achieved using A-PPDU aggregation because each SF can require a lower signal-to-noise ratio (SNR) than the data symbols for demodulation, thereby allowing the length field to be relied on in order to delineate each PSDU.

Traditionally, a management frame can be aggregated with other frames using A-PPDU frame aggregation as long as the management frame is the last frame in an aggregated frame. A management frame is the last frame because, for example, a unicast management frame lacks a QoS control field to specify acknowledgement policy and therefore requires an immediate acknowledgment response. As a result, A-PPDU aggregation for management frames has traditionally been difficult and minimally useful.

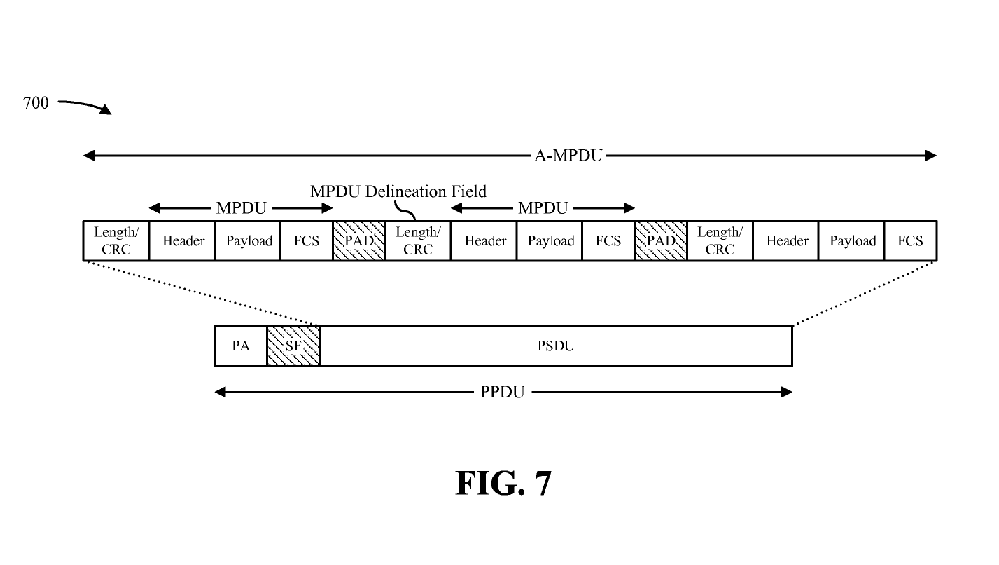

Turning to FIG. 7, a diagram 700 is provided that illustrates A-MPDU frame aggregation. In accordance with one aspect, an A-MPDU frame can contain an MPDU delineation field that is transmitted at a data rate that makes it more efficient than A-PPDU frame aggregation. Additionally and/or alternatively, MPDU frames within an A-MPDU frame may require the addition of padding bits such that delineation fields associated with the respective MPDUs are aligned with 32-bit word boundaries, thereby easing delineation search logic. In one example, A-MPDU aggregation can be done in the lower MAC. For example, a lower MAC initiator for A-MPDU aggregation can inform a physical layer module that a frame currently in transit is an A-MPDU frame. In response, the physical layer module can set an aggregation bit in the HT signal field of the A-MPDU frame. On the receive side, the physical layer can receive the aggregation bit and inform the lower MAC layer to begin an A-MPDU delineation search and thus de-aggregate into each MPDU.

Diagram 700 illustrates an example of a manner in which MPDUs can be aggregated in an A-MPDU frame. In one example, MPDU delineation fields for respective MPDUs can contain a 4-bit reserved field, a 12-bit Length field that can represent the number of octets in the associated MPDU frame, an 8-bit CRC field for the proceeding 16 bits, and an 8-bit unique Word/Pattern field that can represent a constant pattern such as the ASCII code for the character “N.” In one example, the Word/Pattern field can be utilized to search for a MPDU delineation field from within an A-MPDU frame. In accordance with another aspect, A-MPDU aggregation can allow the aggregation of a management frame provided that the management frame is the final frame in a burst in a similar manner to A-PPDU aggregation. Similar to A-PPDU aggregation, a management frame is the last frame in an A-MPDU frame because, for example, a unicast management frame lacks a QoS control field to specify acknowledgement policy and therefore requires an immediate acknowledgment response. As a result, A-MPDU aggregation for management frames has traditionally been met with similar difficulties as A-PPDU management frame aggregation.

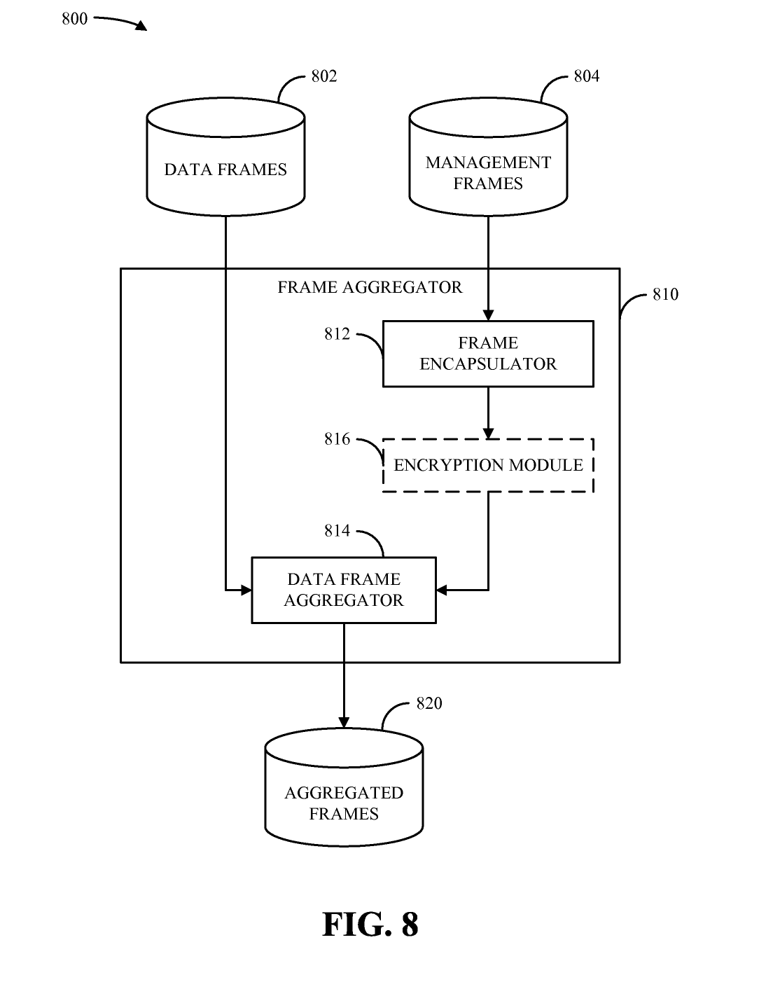

FIG. 8 is a block diagram of a system 800 for management frame encapsulation and aggregation in accordance with various aspects. In accordance with one aspect, system 800 includes a frame aggregator 810, which can overcome the shortcomings of traditional frame aggregation as described with respect to FIGS. 5-7 supra by facilitating the aggregation of data frames 802 and management frames 804. In one example, frame aggregator 810 facilitates aggregation of management frames 804 with data frames 802 by encapsulating management frames 804 into respective data frames at a frame encapsulator 812 to create data-encapsulated management frames. In one example, data-encapsulated management frames can be created by frame encapsulator 812 by creating data frames and embedding information from respective management frames 804 to be encapsulated into the created data frames. By encapsulating management frames 804 into data frames at frame encapsulator 812, frame encapsulator 812 can enable the aggregation of management frames 804 using A-PPDU, A-MPDU, A-MSDU, and/or any other suitable aggregation scheme at a data frame aggregator 814 to create aggregated frames 820. For example, frame encapsulator 812 can include acknowledgement policy indications in data-encapsulated management frames, which are generally required for aggregation as described with respect to FIGS. 5-7 supra. In addition, data-encapsulated management frames can be handled by a transmitter in a similar manner to other data frames. In one example, data-encapsulated management frames can be assigned to a unique traffic access category (e.g., Traffic Class Identifier or TCID), such as best effort (e.g., highest priority) and/or another suitable category.

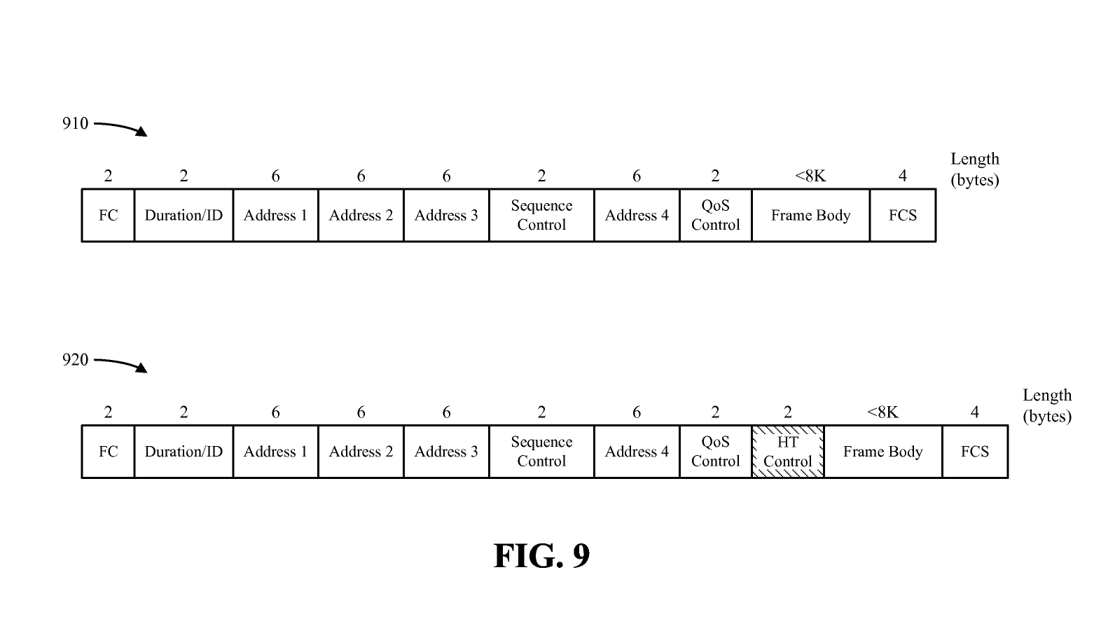

In accordance with one aspect, data frames 802 and management frames 804 encapsulated into data frames by frame encapsulator 812 can include a High Throughput (HT) Control Field, which can provide acknowledgement policy control functionality for the respective frames. By way of example, HT Control Fields can be added to respective data frames as illustrated in FIG. 9. Diagram 910 in FIG. 9 illustrates a data frame format without a HT Control Field, while diagram 920 illustrates a data frame format with a HT Control Field added. While the HT Control Field is illustrated in diagram 920 as located after a QoS Control Field and before a frame body, it should be appreciated that the HT Control Field could be located at any suitable location within a frame. In one example, the HT Control Field can contain indicators to signal the presence of a data-encapsulated management frame to a recipient device. By way of specific, non-limiting example, two one-bit indicators can be utilized at any suitable location within the HT Control Field. In such an example, the first indicator can specify whether a given data frame is a data-encapsulated management frame, and the second indicator can specify whether a data-encapsulated management frame requires encryption. Based on these indicators, a MAC layer logical module and/or another appropriate frame processing module can pass a management frame to frame encapsulator 812. In another example, the HT Control Field can contain additional information, such as an A-MSDU Aggregation bit, rate feedback, reverse link data information (e.g., available TXOP time), piggybacking indicators, and the like.

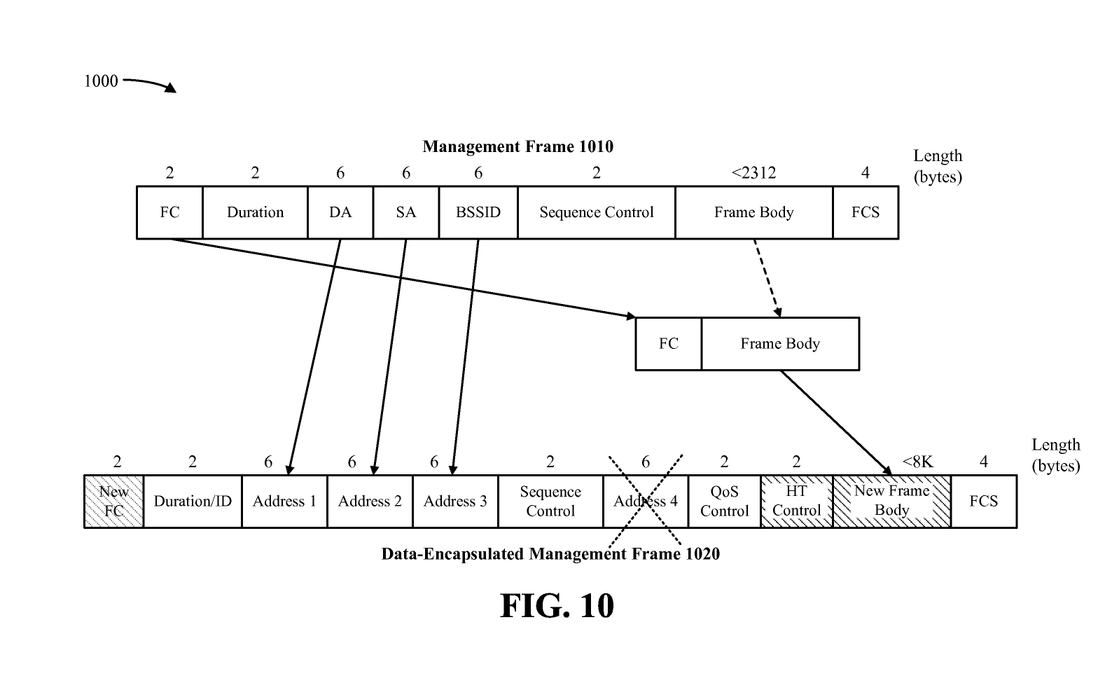

Based on the data frame format illustrated in diagram 920, frame encapsulator 812 can encapsulate a management frame into a data frame for aggregation as illustrated by diagram 1000 in FIG. 10. As diagram 1000 illustrates, selected fields from a management frame 1010, such as the Destination Address (DA), Source Address (SA), and Basic Service Set Identifier (BSSID) fields, can be provided in respective address fields of a corresponding data-encapsulated management frame 1020. Further, as illustrated by diagram 1000, fewer than all Address Fields in a data-encapsulated management frame 1020 can be used. In one example, the Sequence Control for the data-encapsulated management frame 1020 can be assigned in the same manner that data queues are assigned. For example, specific Sequence Control fields can be used for each TCID flow.

As diagram 1000 additionally illustrates, a data-encapsulated management frame 1020 can be configured to have two Frame Control (FC) fields. In one example, a first FC field can be inserted in the header of the data-encapsulated management frame 1020. The first FC field can contain, for example, type and subtype fields corresponding to a data frame (e.g., Type=10 and Subtype=1000-1100) with all other bits in the FC field taken from a FC field and/or another suitable portion of management frame 1010. Additionally and/or alternatively, a second FC field can be the FC field of management frame 1010, which can be prepended to the body of management frame 1010 and inserted into the body of data-encapsulated management frame 1020 such that the MAC layer of a receiving entity can obtain the management information within data-encapsulated management frame 1020. Alternatively, signaling bits could be used in the HT Control Field of data-encapsulated management frame 1020 to convey the presence of management information as described supra with regard to FIG. 9.

In one example, frame aggregator 810 can aggregate data frames 802 and/or management frames 804 using one or more aggregation schemes and can adaptively select one or more aggregation schemes for use during a particular aggregation operation. By way of example, upon receiving a management frame 804 destined for a given receiver, frame aggregator 810 can determine whether there are other data frames 802 destined to the same receiver. If it is determined that other data frames 802 are destined to the receiver, frame aggregator can aggregate the management frame 804 and the data frames 802 into an A-MSDU frame. On the other hand, in the event that the management frame 804 is the only frame destined to a receiver, frame aggregator 810 can instead facilitate the aggregation of the management frame 804 with other data frames 802 for other receivers using A-PPDU or A-MPDU aggregation schemes at the lower layer MAC. Frame aggregator 810 can then select an appropriate acknowledgement policy, such as “block-ACK,” such that inefficiency associated with awaiting an acknowledgement after each transmitted frame is eliminated. Alternatively, frame aggregator 810 can facilitate the aggregation of all frames at the lower layer MAC. In such a case, frame aggregator 810 can utilize A-PPDU and/or A-MPDU aggregation and elect not to utilize A-MSDU aggregation. In another alternative, a new frame format having new Type and/or Subtype fields can be defined and utilized for unicast management frames 804 in order to allow frame aggregator 810 to include a QoS Control Field in the management frames 804 that can specify an acknowledgement policy (e.g., no-ACK or block-ACK).

In accordance with one aspect, frame encapsulator 812 can set a bit in a predetermined field of each data-encapsulated management frame, such as a MGMT bit, to indicate the presence of management information in the frame. In addition, frame aggregator 810 can facilitate the encryption of management frames 804 aggregated into one or more aggregated frames 820. For example, frame encapsulator 812 can set an additional bit, such as a MGMT EN bit, in each data-encapsulated management frame for which encryption is desired. Data-encapsulated management frames can then be provided to an encryption module 816, where an encryption operation can be performed on frames for which the encryption bit is set. The encrypted frames can then be provided to data frame aggregator 814 for aggregation.

Upon the creation of aggregated frames 820 as illustrated by system 800, the aggregated frames 820 can be transmitted to one or more stations. At a receiving station, a header processing engine can parse the QoS Control Field of each frame within a received aggregated frame 820. If the QoS Control Field indicates that a HT Control Field is present for a given frame, the header processing engine can utilize the HT Control Field to determine whether the corresponding frame is a data-encapsulated management frame. For example, the header processing engine can determine if a MGMT bit is set within the HT Control Field of the frame. If the MGNT bit is set, the receiving station can then perform a decapsulation operation to obtain the management information from the frame. Next, depending on whether an encryption bit, such as a MGMT EN bit, is set within the frame, the receiving station can decrypt the management information and/or provide the management information to the upper layer MAC for further processing.

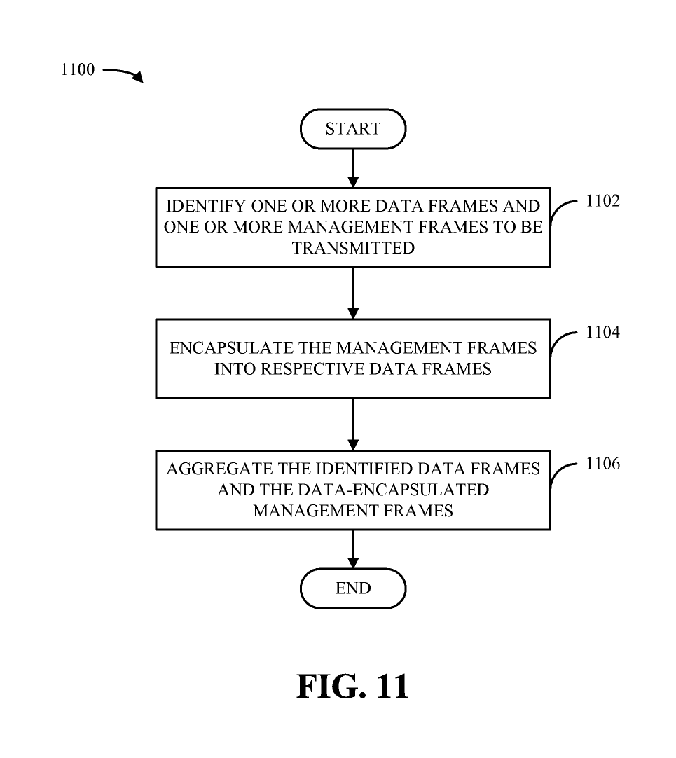

Referring to FIGS. 11-13, methodologies for frame aggregation in a wireless communication system are illustrated. While, for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

With reference to FIG. 11, illustrated is a methodology 1100 for enhanced management frame aggregation in a wireless communication system (e.g., system 200). It is to be appreciated that methodology 1100 can be performed by, for example, an access point (e.g., transmitting station 220) and/or any other appropriate network entity. Methodology 1100 begins at block 1102, wherein one or more data frames (e.g., data frames 802) and one or more management frames (e.g., management frames 804) to be transmitted are identified. Next, at block 1104, the management frames identified at block 1102 are encapsulated into respective data frames (e.g., by a frame encapsulator 812 at a frame aggregator 810). In one example, a control field provided in respective data frames into which management frames are encapsulated at block 1104 can provide indications that the data frames contain management information. The control fields utilized for this indication can be existing control fields in data frames utilized by a system in which methodology 1100 is performed, or alternatively the control fields can be added to the data frames for aggregation. In addition, such a control field can specify an acknowledgement policy for the management frames encapsulated at block 1104, thereby mitigating the traditional inefficiencies associated with the transmission of management frames. In one example, management frames can additionally be encrypted before, during, or after encapsulation at block 1104 (e.g., by an encryption module 816). In the event that a management frame is encrypted, an additional indication can be provided to indicate that management information contained within a data frame is encrypted.

Upon completing the act described at block 1104, methodology 1100 can conclude at block 1106, wherein the data frames identified at block 1102 and the management frames encapsulated at block 1104 are aggregated (e.g., by a data frame aggregator 814 to create aggregated frames 820). In accordance with one aspect, aggregation can be performed at block 1106 using A-MSDU, A-MPDU, and/or A-PPDU aggregation schemes and/or any other appropriate aggregation scheme or combination thereof. In one example, aggregation at block 1106 can enable aggregated frames to be transmitted using a block acknowledgement scheme in order to allow multiple data and/or management frames to be communicated and processed at a receiver without requiring separate response for each frame.

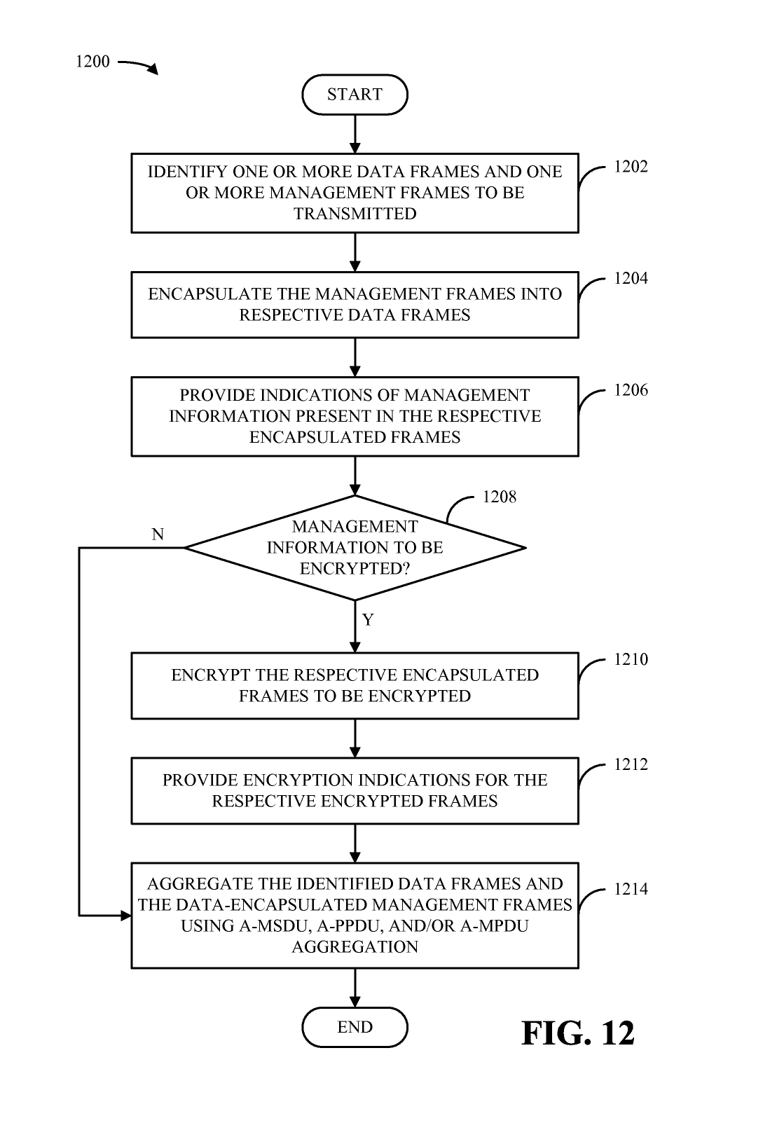

FIG. 12 illustrates a methodology 1200 for management frame encapsulation and aggregation. It is to be appreciated that methodology 1200 can be performed by, for example, an access point and/or any other appropriate entity in a wireless communication system. Methodology 1200 begins at block 1202, wherein one or more data frames and one or more management frames to be transmitted are identified. Next, at block 1204, the management frames identified at block 1202 are encapsulated into respective data frames. In one example, encapsulation at block 1204 can be achieved by populating a data frame with information from a management frame identified at block 1202 as generally described supra with regard to FIG. 10. In another example, a data frame into which a management frame is encapsulated at block 1204 can include acknowledgement policy information in order to facilitate the use of block-ACK, no-ACK, and/or other similar acknowledgement policies for the transmission of management frames. At block 1206, indications are provided that relate the presence of management information in the respective encapsulated frames created at block 1204. Indications can be provided at block 1206 by, for example, setting a MGMT bit and/or another appropriate bit or combination of bits within respective encapsulated frames.

Upon completing the act described at block 1206, methodology 1200 can proceed to block 1208, where it is determined whether management information in one or more frames encapsulated at block 1204 is to be encrypted. Upon a positive determination at block 1208, methodology 1200 can proceed to block 1210, wherein the encapsulated frames for which encryption is desired are encrypted. In accordance with one aspect, encryption at block 1210 can be performed using any suitable encryption technique and/or combination thereof. For example, an encryption operation can be performed based on a key, cryptosync, and/or other secret parameter known to an entity performing methodology 1200 and/or an entity to which a corresponding encrypted frame is to be transmitted. Next, at block 1212, encryption indications are provided for the respective frames encrypted at block 1210. Encryption indications at block 1212 can be provided, for example, by setting a MGMT EN bit and/or another appropriate bit or combination of bits within respective encrypted frames.

Upon completing the act described at block 1212, or upon a negative determination at block 1208, methodology 1200 can conclude at block 1214, wherein the data frames identified at block 1202 and the data-encapsulated management frames created at blocks 1204-1212 are aggregated using A-MSDU, A-PPDU, and/or A-MPDU aggregation. In accordance with one aspect, an aggregation scheme utilized at block 1214 can be selected based on any appropriate criteria. By way of non-limiting example, A-MSDU aggregation can be selected in the event that multiple frames are present for transmission to a single receiver. In another specific example, A-PPDU aggregation can be selected in the event that frames are present for transmission to multiple receivers at different rates. In accordance with another aspect, aggregated frames can be transmitted upon aggregation at block 1214 using a block acknowledgement scheme to allow the communication of multiple data and/or management frames without requiring a separate response period for each frame.

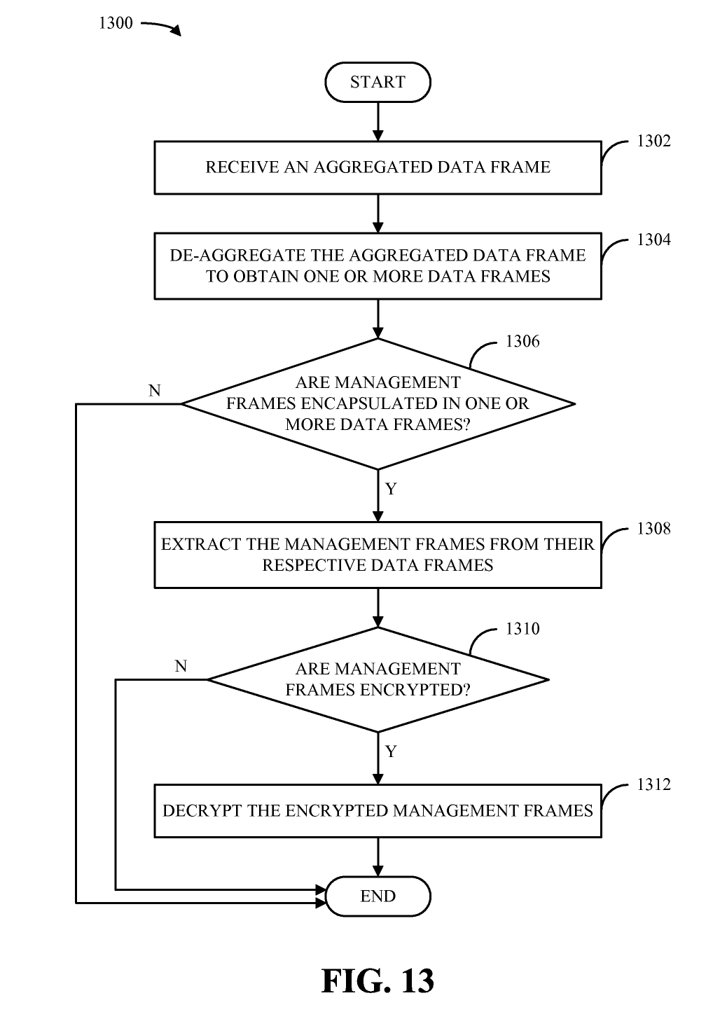

FIG. 13 illustrates a methodology 1300 for receiving and processing aggregated management frames. It is to be appreciated that methodology 1300 can be performed by, for example, a receiving station (e.g., receiving station 240) and/or any other appropriate network entity. Methodology 1300 begins at block 1302, wherein an aggregated data frame is received (e.g., by a receiver 244 via an antenna 242). Next, at block 1304, the aggregated data frame received at block 1302 is de-aggregated (e.g., by a frame de-aggregator 246) to obtain one or more data frames within the aggregated frame. At block 1306, it is then determined whether management frames have been encapsulated in one or more of the data frames obtained at block 1304. In one example, the determination at 1306 can be performed by checking for the presence of a set MGMT bit and/or another suitable indicator in the respective data frames. Methodology 1300 can conclude upon a negative determination at block 1306 or proceed to block 1308 upon a positive determination, wherein the management frames are extracted from the respective data frames into which they have been encapsulated.

Methodology 1300 can then proceed to block 1310, wherein it is determined whether the management frames extracted at block 1308 are encrypted. In one example, the determination at block 1310 can be conducted by checking for the presence of a MGMT EN bit in the data frames from which the management frames are extracted at block 1308. Upon a negative determination at block 1310, methodology 1300 can conclude. Otherwise, methodology 1300 can proceed to block 1312 prior to concluding, wherein the encrypted management frames determined at block 1310 are decrypted. Decryption at block 1312 can be performed using any suitable decryption operation. Further, decryption at block 1312 can utilize a key, cryptosync, and/or other secret value calculated by, communicated to, or otherwise known by an entity performing methodology 1300.

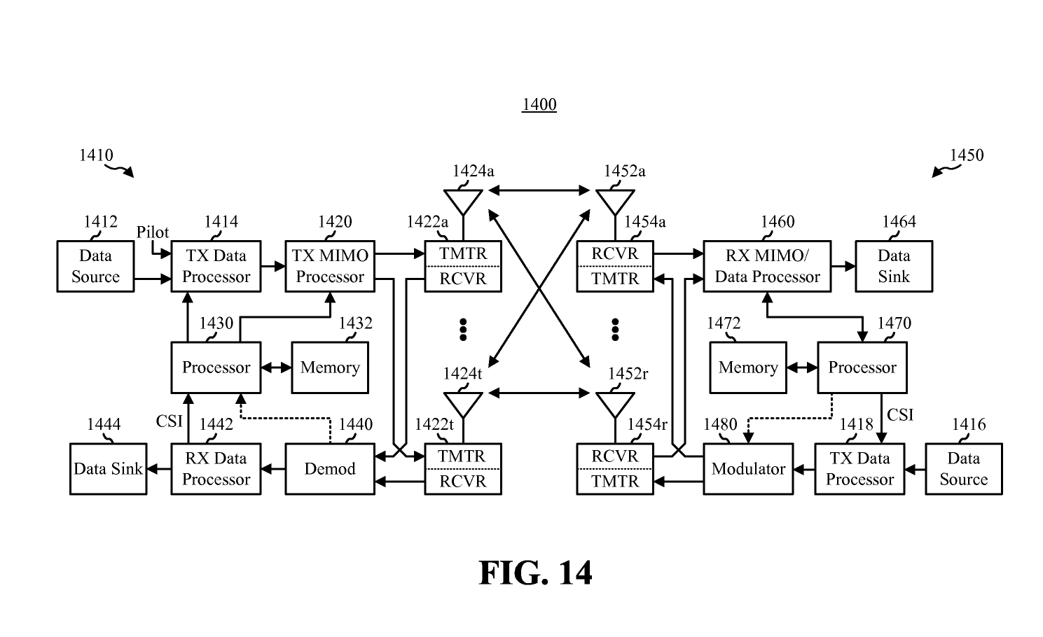

Referring now to FIG. 14, a block diagram illustrating an example wireless communication system 1400 in which one or more embodiments described herein can function is provided. In one example, system 1400 is a multiple-input multiple-output (MIMO) system that includes a transmitter system 1410 and a receiver system 1450. It should be appreciated, however, that transmitter system 1410 and/or receiver system 1450 could also be applied to a multi-input single-output (MISO) system wherein, for example, multiple transmit antennas (e.g., on a base station), can transmit one or more symbol streams to a single antenna device (e.g., a mobile station). Additionally, it should be appreciated that aspects of transmitter system 1410 and/or receiver system 1450 described herein could be utilized in connection with a single output to single input (SISO) antenna system.

In accordance with one aspect, traffic data for a number of data streams are provided at transmitter system 1410 from a data source 1412 to a transmit (TX) data processor 1414. In one example, each data stream can then be transmitted via a respective transmit antenna 1424. Additionally, TX data processor 1414 can format, code, and interleave traffic data for each data stream based on a particular coding scheme selected for each respective data stream in order to provide coded data. In one example, the coded data for each data stream can then be multiplexed with pilot data using OFDM techniques. The pilot data can be, for example, a known data pattern that is processed in a known manner. Further, the pilot data can be used at receiver system 1450 to estimate channel response. Back at transmitter system 1410, the multiplexed pilot and coded data for each data stream can be modulated (i.e., symbol mapped) based on a particular modulation scheme (e.g., BPSK, QSPK, M-PSK, or M-QAM) selected for each respective data stream in order to provide modulation symbols. In one example, data rate, coding, and modulation for each data stream can be determined by instructions performed on and/or provided by processor 1430.

Next, modulation symbols for all data streams can be provided to a TX processor 1420, which can further process the modulation symbols (e.g., for orthogonal frequency division multiplexing or OFDM). TX MIMO processor 1420 can then provides NT modulation symbol streams to NT transceivers 1422a through 1422t. In one example, each transceiver 1422 can receive and process a respective symbol stream to provide one or more analog signals. Each transceiver 1422 can then further condition (e.g., amplify, filter, and upconvert) the analog signals to provide a modulated signal suitable for transmission over a MIMO channel. Accordingly, NT modulated signals from transceivers 1422a through 1422t can then be transmitted from NT antennas 1424a through 1424t, respectively.

In accordance with another aspect, the transmitted modulated signals can be received at receiver system 1450 by NR antennas 1452a through 1452r. The received signal from each antenna 1452 can then be provided to respective transceivers 1454. In one example, each transceiver 1454 can condition (e.g., filter, amplify, and downconvert) a respective received signal, digitize the conditioned signal to provide samples, and then processes the samples to provide a corresponding “received” symbol stream. An RX MIMO/data processor 1460 can then receive and process the NR received symbol streams from NR transceivers 1454 based on a particular receiver processing technique to provide NT “detected” symbol streams. In one example, each detected symbol stream can include symbols that are estimates of the modulation symbols transmitted for the corresponding data stream. RX processor 1460 can then process each symbol stream at least in part by demodulating, deinterleaving, and decoding each detected symbol stream to recover traffic data for a corresponding data stream. Thus, the processing by RX processor 1460 can be complementary to that performed by TX MIMO processor 1420 and TX data processor 1414 at transmitter system 1410. RX processor 1460 can additionally provide processed symbol streams to a data sink 1464.

In accordance with one aspect, the channel response estimate generated by RX processor 1460 can be used to perform space/time processing at the receiver, adjust power levels, change modulation rates or schemes, and/or other appropriate actions. Additionally, RX processor 1460 can further estimate channel characteristics such as, for example, signal-to-noise-and-interference ratios (SNRs) of the detected symbol streams. RX processor 1460 can then provide estimated channel characteristics to a processor 1470. In one example, RX processor 1460 and/or processor 1470 can further derive an estimate of the “operating” SNR for the system. Processor 1470 can then provide channel state information (CSI), which can comprise information regarding the communication link and/or the received data stream. This information can include, for example, the operating SNR. The CSI can then be processed by a TX data processor 1418, modulated by a modulator 1480, conditioned by transceivers 1454a through 1454r, and transmitted back to transmitter system 1410. In addition, a data source 1416 at receiver system 1450 can provide additional data to be processed by TX data processor 1418.

Back at transmitter system 1410, the modulated signals from receiver system 1450 can then be received by antennas 1424, conditioned by transceivers 1422, demodulated by a demodulator 1440, and processed by a RX data processor 1442 to recover the CSI reported by receiver system 1450. In one example, the reported CSI can then be provided to processor 1430 and used to determine data rates as well as coding and modulation schemes to be used for one or more data streams. The determined coding and modulation schemes can then be provided to transceivers 1422 for quantization and/or use in later transmissions to receiver system 1450. Additionally and/or alternatively, the reported CSI can be used by processor 1430 to generate various controls for TX data processor 1414 and TX MIMO processor 1420. In another example, CSI and/or other information processed by RX data processor 1442 can be provided to a data sink 1444.

In one example, processor 1430 at transmitter system 1410 and processor 1470 at receiver system 1450 direct operation at their respective systems. Additionally, memory 1432 at transmitter system 1410 and memory 1472 at receiver system 1450 can provide storage for program codes and data used by processors 1430 and 1470, respectively. Further, at receiver system 1450, various processing techniques can be used to process the NR received signals to detect the NT transmitted symbol streams. These receiver processing techniques can include spatial and space-time receiver processing techniques, which can also be referred to as equalization techniques, and/or “successive nulling/equalization and interference cancellation” receiver processing techniques, which can also be referred to as “successive interference cancellation” or “successive cancellation” receiver processing techniques.

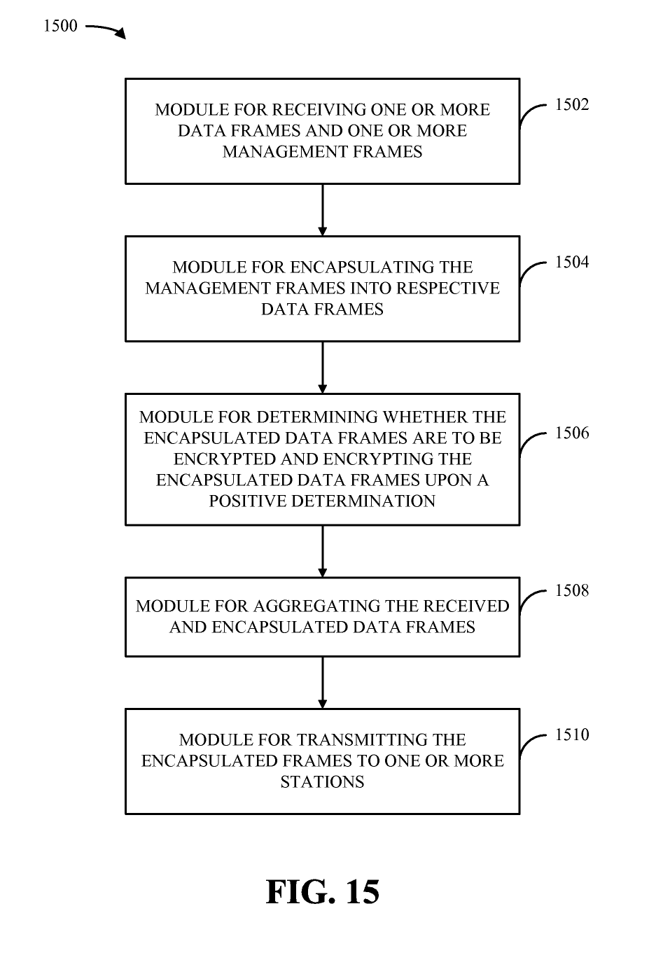

FIG. 15 illustrates an apparatus 1500 that facilitates enhanced management frame aggregation in a wireless communication system (e.g., system 200). It is to be appreciated that apparatus 1500 is represented as including functional blocks, which can be functional blocks that represent functions implemented by a processor, software, or combination thereof (e.g., firmware). Apparatus 1500 can be implemented in a base station (e.g., transmitting station 220) and/or another suitable network entity and can include a module 1502 for receiving one or more data frames and one or more management frames, a module 1504 for encapsulating the management frames into respective data frames, a module 1506 for determining whether the encapsulated data frames are to be encrypted and encrypting the encapsulated data frames upon a positive determination, a module 1508 for aggregating the received and encapsulated data frames, and a module 1510 for transmitting the encapsulated data frames to one or more stations.

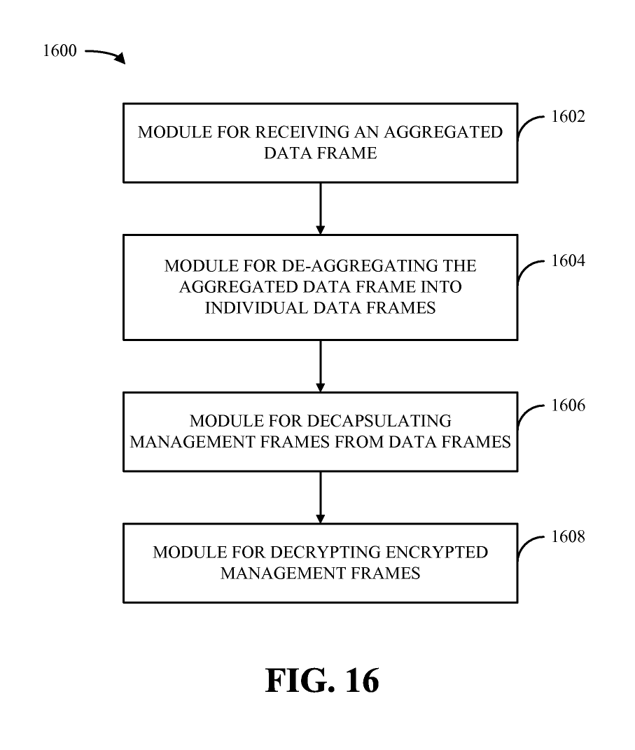

FIG. 16 illustrates an apparatus 1600 that facilitates utilization of aggregated and encapsulated management frames in a wireless communication system. It is to be appreciated that apparatus 1600 is represented as including functional blocks, which can be functional blocks that represent functions implemented by a processor, software, or combination thereof (e.g., firmware). Apparatus 1600 can be implemented in a mobile station (e.g., receiving station 240) and/or another suitable network entity and can include a module 1602 for receiving an aggregated data frame, a module 1604 for de-aggregating the aggregated data frame into individual data frames, a module 1606 for decapsulating management frames from data frames, and a module 1608 for decrypting encrypted management frames.

It is to be understood that the aspects described herein can be implemented by hardware, software, firmware, middleware, microcode, or any combination thereof. When the systems and/or methods are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

In addition, while the above aspects are described with reference to PSDUs, MPDUs, and other terminology commonly associated with various wireless communication standards, it should be appreciated that the described aspects are not limited to those standards and can be utilized in connection with a variety of wireless networking standards. More generally, the described aspects can be utilized in any wireless network in which multiple information-containing frames of variable length are aggregated prior to transmission in order to reduce overhead associated with transmitting multiple frames. Any number of frames can be aggregated, and the frames may be of any size desired. Moreover, it should be appreciated that the particular content of a given frame is not critical to the described aspects.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.

What is claimed is:

1. A method for transmitting information in a wireless communication system, comprising:
identifying a plurality of frames to be transmitted, the frames comprising one or more data frames for communicating data within the wireless communication system according to a data frame protocol and one or more management frames for communicating management information within the wireless communication system according to a management frame protocol; and
encapsulating a management frame into a data frame such that the management frame can be communicated as a data frame according to the data frame protocol.

2. The method of claim 1, further comprising aggregating the encapsulated management frame and one or more other frames to create an aggregate frame, the one or more other frames comprising at least one of a data frame or a previously encapsulated management frame.

3. The method of claim 2, wherein the aggregating comprises aggregating the encapsulated management frame and the at least one data frame using Aggregate Medium Access Control Service Data Unit (A-MSDU) aggregation.

4. The method of claim 2, wherein the aggregating comprises aggregating the encapsulated management frame and the at least one data frame using Aggregate Medium Access Control Protocol Data Unit (A-MPDU) aggregation.

5. The method of claim 2, wherein the aggregating comprises aggregating the encapsulated management frame and the at least one data frame using Aggregate Physical Layer Convergence Procedure Protocol Data Unit (A-PPDU) aggregation.

6. The method of claim 2, wherein the aggregating comprises including a block acknowledgement request in the aggregate frame, the block acknowledgement request allows a single acknowledgement to be used for the aggregate frame.

7. The method of claim 6, further comprising transmitting the aggregate frame to a receiver and receiving a block acknowledgement from the receiver in response to the aggregated frame, the block acknowledgement specifies acknowledgements or negative acknowledgements for respective frames within the aggregate frame.

8. The method of claim 7, further comprising re-transmitting respective frames for which the block acknowledgment specifies a negative acknowledgement.

9. The method of claim 1, wherein the one or more management frames respectively comprise one or more address fields and a frame body and the encapsulating comprises:
creating a data frame comprising one or more address fields and a frame body;
embedding information contained in the respective address fields of a management frame into respective address fields of the created data frame; and
embedding management information contained in the frame body of the management frame into the frame body of the created data frame.

10. The method of claim 9, wherein the created data frame further comprises one or more control fields and the encapsulating further comprises including an indication of management information in a control field of the created data frame.

11. The method of claim 1, wherein the encapsulating comprises:
encrypting a management frame;
encapsulating the encrypted management frame into a data frame; and
providing an indication in the data frame to indicate that the management frame encapsulated in the data frame is encrypted.

12. A wireless communications apparatus, comprising:
a memory that stores data relating to one or more management frames; and
a processor configured to encapsulate the one or more management frames into respective data frames and to aggregate the encapsulated management frames into one or more aggregated frames.

13. The wireless communications apparatus of claim 12, wherein the memory further stores data relating to one or more data frames and the processor is further configured to aggregate the encapsulated management frames with the one or more data frames.

14. The wireless communications apparatus of claim 13, wherein the one or more data frames are communicated by the wireless communications apparatus according to a data frame protocol, the one or more management frames are communicated by the wireless communications apparatus according to a management frame protocol, and the processor is configured to encapsulate the one or more management frames into respective data frames in order to allow the management frames to be communicated as data frames using the data frame protocol.

15. The wireless communications apparatus of claim 12, wherein the processor is further configured to aggregate the encapsulated management frames using at least one of an A-MSDU, A-MPDU, or A-PPDU aggregation scheme.

16. The wireless communications apparatus of claim 12, wherein the processor is further configured to specify a block acknowledgement policy for aggregated frames such that a single acknowledgement can be communicated in response to respective aggregated frames.

17. The wireless communications apparatus of claim 16, wherein the processor is further configured to specify a block acknowledgement policy for an aggregated frame explicitly at least in part by aggregating a frame containing a request for a block acknowledgement into the aggregated frame.

18. The wireless communications apparatus of claim 16, wherein the processor is further configured to specify a block acknowledgement policy for an aggregated frame implicitly at least in part by embedding a request for a block acknowledgement into at least one frame aggregated into the aggregated frame.

19. The wireless communications apparatus of claim 16, wherein the processor is further configured to instruct transmission of an aggregated frame and to receive a block acknowledgment in response to the aggregated frame.

20. The wireless communications apparatus of claim 12, wherein the processor is further configured to configure respective encapsulated management frames to indicate management information contained in the respective encapsulated management frames.

21. The wireless communications apparatus of claim 20, wherein the processor is further configured to indicate management information contained in the respective encapsulated management frames at least in part by setting one or more indicator bits in respective control fields of the respective encapsulated management frames.

22. The wireless communications apparatus of claim 12, wherein the processor is further configured to encrypt a management frame prior to encapsulating the management frame and to configure a data frame into which the encrypted management frame is encapsulated to indicate encrypted management information contained in the data frame.

23. The wireless communications apparatus of claim 21, wherein the processor is further configured to indicate encrypted management information contained in the data frame into which the encrypted management frame is encapsulated at least in part by setting one or more indicator bits in a control field of the data frame.

24. An apparatus that facilitates frame aggregation in a wireless communication system, comprising:
means for receiving one or more data frames and one or more management frames;
means for encapsulating the management frames into one or more data frames; and
means for aggregating the one or more received data frames and the encapsulated management frames.

25. A computer-readable medium, comprising:
code for causing a computer to identify a plurality of frames for transmission, the frames comprising at least one data frame and at least one management frame;
code for causing a computer to encapsulate a management frame into a data frame such that the management frame can be communicated as a data frame;
code for causing a computer to aggregate the encapsulated management frame with one or more data frames or previously encapsulated management frames; and
code for causing a computer to instruct transmission of the aggregated frames with a request for a block acknowledgment in response to the aggregated frames.

26. An integrated circuit that executes computer-executable instructions for coordinating transmission of management information, the instructions comprising:
receiving a management frame to be transmitted; and
encapsulating the management frame into a data frame to enable aggregation and transmission of the management frame as a data frame.

27. A method for processing information in a wireless communication system, comprising:
receiving an aggregate frame, the aggregate frame comprises a plurality of subframes constructed according to a data frame format, at least one subframe contains a management frame containing management information;
de-aggregating the aggregate frame to obtain the subframes contained within the aggregate frame; and
obtaining management information from a subframe at least in part by decapsulating the subframe to obtain a management frame contained therein.

28. The method of claim 27, wherein the obtaining management information comprises:
receiving an indication of a management frame contained within a subframe within the aggregate frame; and
decapsulating the subframe within the aggregate frame for which the indication was received to obtain the management frame contained therein.

29. The method of claim 28, wherein the indication of a management frame within a subframe is provided within a control field of the subframe.

30. The method of claim 27, wherein the obtaining management information comprises:
receiving an indication of an encrypted management frame within a subframe;
decapsulating the subframe for which the indication was received to obtain the management frame contained therein; and
decrypting the management frame.

31. The method of claim 27, further comprising transmitting a block acknowledgement in response to receiving the aggregate frame.

32. The method of claim 27, wherein the obtaining management information from a subframe comprises:
obtaining address information corresponding to a management frame contained within the subframe from one or more address fields of the subframe; and
obtaining management information corresponding to the management frame from a frame body of the subframe.

33. A wireless communications apparatus, comprising:
a memory that stores data relating to an aggregated frame comprising a plurality of data frames; and
a processor configured to obtain the plurality of data frames from the aggregated frame and to derive management information from a data frame at least in part by extracting a management frame from the data frame.

34. The wireless communications apparatus of claim 33, wherein the memory further stores data relating to a management frame indication provided in a data frame within the aggregated frame and the processor is further configured to extract a management frame from the data frame in which the management frame indication is provided.

35. The wireless communications apparatus of claim 34, wherein the memory further stores data relating to an encryption indication provided in the data frame in which the management frame is contained and the processor is further configured to decrypt the management frame upon extracting the management frame.

36. The wireless communications apparatus of claim 33, wherein the processor is further configured to receive the aggregated frame and to transmit a block acknowledgement to an entity from which the aggregated frame was received.

37. The wireless communications apparatus of claim 33, wherein the processor is further configured to derive address information corresponding to a management frame from one or more address fields of a data frame in which the management frame is contained and to derive management information corresponding to the management frame from a frame body of the data frame in which the management frame is contained.

38. An apparatus that facilitates receiving and processing an aggregated frame in a wireless communication system, comprising:
means for receiving an aggregated data frame containing a plurality of data frames;
means for de-aggregating the aggregated data frame into the plurality of data frames; and
means for decapsulating respective management frames from respective data frames in which management frames are encapsulated.

39. A computer-readable medium, comprising:
code for causing a computer to identify an aggregate frame comprising a plurality of data subframes;
code for causing a computer to identify a data subframe that contains a management frame; and
code for causing a computer to extract the management frame from the identified data subframe.

40. An integrated circuit that executes computer-executable instructions for obtaining management information from an aggregate frame, the instructions comprising:
receiving an aggregate frame comprising a plurality of subframes;
identifying information provided in one or more subframes that indicates the presence of respective management frames encapsulated in the one or more subframes; and
decapsulating the one or more subframes in which respective management frames are encapsulated to extract the management frames.
